(19) United States
(12) Patent Application Publication
(10) Pub. No.: US 2016/0322710 A1
(43) Pub. Date: Nov. 3, 2016

(54) SEGMENTED STRUCTURE, IN PARTICULAR FOR A SATELLITE ANTENNA REFLECTOR, PROVIDED WITH AT LEAST ONE ROTATIONAL AND TRANSLATIONAL DEPLOYMENT DEVICE

(71) Applicant: AIRBUS DEFENCE AND SPACE SAS, Les Mureaux (FR)

(72) Inventor: Sylvain Grosroyat, Maule (FR)

(73) Assignee: AIRBUS DEFENCE AND SPACE SAS, Les Mureaux (FR)

(21) Appl. No.: 15/102,491

(22) PCT Filed: Dec. 10, 2014
(86) PCT No.: PCT/FR2014/000268

§ 371 Date: Jun. 7, 2016

(30) Foreign Application Priority Data
Dec. 30, 2013 (FR) 13/03110

(51) Int. Cl. H01Q 15/16; H01Q 1/08; H01Q 1/28; H01Q 3/16

(52) U.S. Cl. CPC H01Q 15/162; H01Q 3/16; H01Q 1/08; H01Q 1/288

(57) ABSTRACT

A segmented structure includes at least two panels, wherein a first panel is referred to as main panel, and a second panel is referred to as secondary panel. The structure also includes at least one deployment device having a connecting arm secured to the rear face of the secondary panel and connected to the rear face of the main panel. The deployment device includes a movement system with a rotation unit that generates a rotation of the connecting arm about a reference axis, and a translation unit that generates a movement of the connecting arm in translation along this reference axis, so as bring the secondary panel into a stowed position or into a deployed position.

The present invention relates to a segmented structure.

Said segmented structure comprises at least two panels which are interconnected and are to be deployed in space.

Although not exclusively, the present invention relates more specifically to a segmented structure which is part of an antenna reflector of a telecommunications satellite, in particular to a large-size antenna reflector, operating in high frequency bands. Such an antenna reflector generally has a rigid structure (referred to as a shell) which is provided with a reflective surface and reinforcing means on the rear of said surface, which are involved in supporting the shell and linking with the satellite.

The large size of the shell of such a reflector poses problems in terms of the overall dimensions when sending a satellite provided with such a reflector into space using a space launcher.

In addition, for rigid reflectors which have diameters of several metres, a segmented structure is provided, which comprises a plurality of panels, in particular a three-panel structure comprising a central panel and two end panels.

This segmented structure also comprises a deployment device for each end panel, which is suitable for bringing the end panel, relative to the main panel:
either into a storage position, in which the end panel is positioned on the main panel on the rear face thereof, the front face of the end panel being directed in the same direction as the front face of the main panel;
or into a deployed position, in which the end panel is positioned alongside and against the main panel so as to form a continuous assembly at least on the front faces thereof.

In a segmented structure of this type, each end panel can thus occupy a storage position for transportation in the space launcher, and a deployed position when the satellite is in space.

The present invention relates to a segmented structure, in particular for a satellite antenna reflector, comprising at least two panels and a deployment device which makes it possible to carry out efficient and advantageous deployment of said two panels in space.

According to the invention, said segmented structure comprising:
at least two panels, a first panel referred to as the main panel, comprising a front face and a rear face, and a second panel referred to as the secondary panel, also comprising a front face and a rear face; and
at least one deployment device which is connected to the respective rear faces of said main and secondary panels and is suitable for bringing said secondary panel into one or the other of the two following positions, relative to said main panel:
   a storage position, in which said secondary panel is positioned at least in part on said main panel on the rear face thereof, the front face of said secondary panel being directed in the same direction as the front face of said main panel; and
   a deployed position in which said secondary panel is positioned towards the outside of the main panel, to the side and against said main panel in order to form a continuous assembly at least on the front faces thereof,
      is characterised in that said deployment device comprises:
a link arm which is rigidly connected, by means of a first of the ends thereof, to the rear face of the secondary panel and which is connected, by means of a second of the ends thereof, to the rear face of the main panel by means of a structural portion; and
a movement system arranged in said structural portion and comprising at least:
   a rotation unit suitable for rotating said link arm about an axis referred to as a reference axis, said link arm being arranged such that rotating said rotation unit allows said secondary panel to be brought directly into one or the other of a first position and a second position relative to said main panel, said first position and said second position being respectively located, in a lateral plane, substantially in said storage position and in a position associated with the deployed position; and
   a translation unit suitable for translating said link arm along said reference axis so as to move said secondary panel relative to said main panel in a direction that is transverse to said lateral plane.

Thus, by means of the invention, the secondary panel of the segmented structure can be deployed simply, efficiently and advantageously in space, from the storage position into the deployed position, as explained below.

Advantageously, the reference axis is defined by the combination of the plane of interface between the secondary panel and the main panel in the storage position and in the deployed position, with the relative position of said secondary and main panels.

Moreover, in a preferred embodiment:
the rotation unit comprises an electric motor coupled to a reducer and acting between a structural element rigidly connected to the rear face of the main panel and said second end of the link arm; and/or
the translation unit comprises an electrically actuated screw-nut system acting between a structural element rigidly connected to the rear face of the main panel and said second end of the link arm.

Preferably, said structural element comprises a support that is provided with fixing feet rigidly connected to the rear face of the main panel.

Furthermore, advantageously:
the link arm is connected, in the region of at least one of the ends thereof, by a housing; and/or
the link arm is provided, at least at the first of the ends thereof (which is connected to the secondary panel), with a flexible element.

Moreover, in a preferred embodiment, the segmented structure comprises:
a central main panel;
two secondary panels arranged on either side of said central main panel in the deployed position so as to have a parabolic shape; and
two deployment devices respectively associated with said secondary panels.

In a preferred embodiment, in the storage position, the two secondary panels are arranged symmetrically with respect to one another, according to a central symmetry relative to a central point of said main panel.

The present invention also relates to:
a satellite antenna reflector which comprises a segmented structure of the above-mentioned type; and
a satellite which comprises at least one segmented structure of this type or one antenna reflector of this type.

The present invention also relates to a method for deploying a segmented structure of the above-mentioned type.

According to the invention, this method comprises successive steps consisting, during deployment from the storage position to the deployed position, in:
a) translating the link arm, to which the secondary panel is connected, in a first translation direction by means of the translation unit, in order to space said secondary panel from said main panel and to bring said secondary panel into said first position;
b) rotating said link arm, to which the secondary panel is connected, in a first rotation direction by means of the rotation unit, in order to bring the secondary panel into said second position; and
c) translating the link arm, to which the secondary panel is connected, in a second translation direction opposite to said first translation direction by means of the translation unit, in order to bring said secondary panel substantially into the same average plane as said main panel.

Advantageously, the method also comprises a step d) consisting in rotating said link arm, to which the secondary panel is connected, in a second rotation direction opposite to said first rotation direction by means of the rotation unit, in order to bring said secondary panel in contact with said main panel in the deployed position.

For a segmented structure having two secondary panels, the translations and rotations of the two secondary panels are preferably carried out simultaneously.

The figures of the accompanying drawings will show how the invention can be carried out. In these figures, same reference numerals denote like elements.

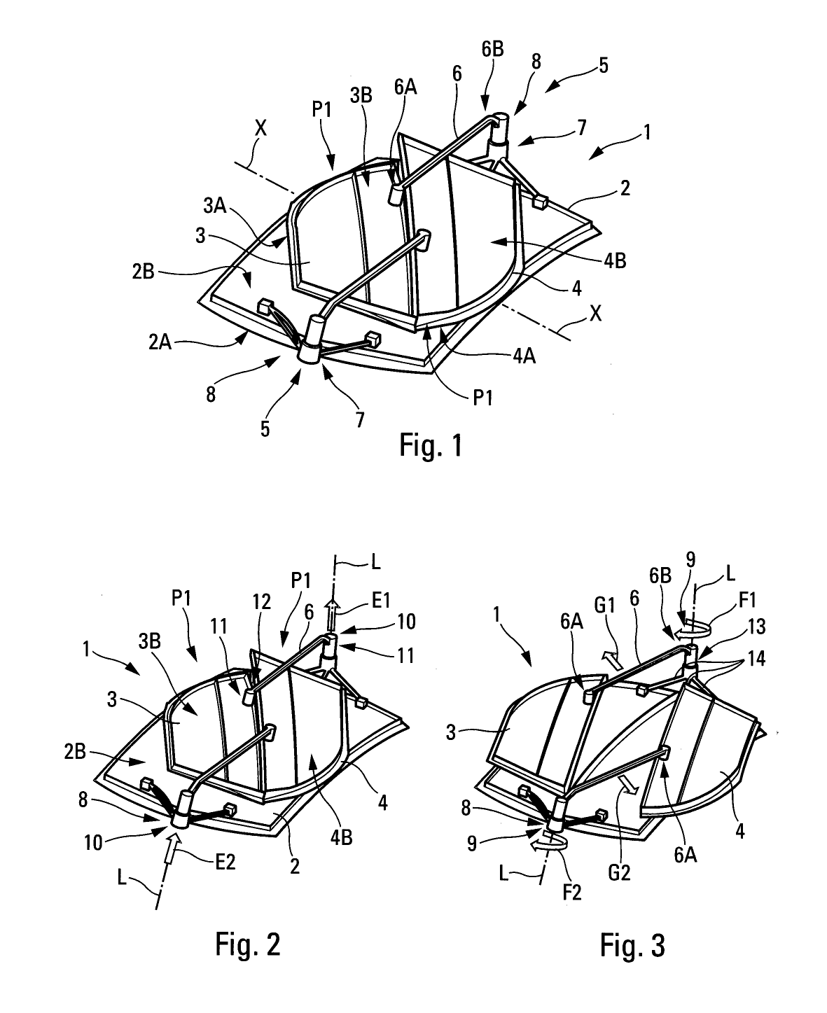

FIG. 1 is a schematic perspective view of a specific embodiment of a segmented structure illustrating the invention and comprising a central main panel as well as two secondary panels, each of which is in a storage position.

FIGS. 2 to 4 show various successive steps of deploying secondary panels with respect to a main panel of a segmented structure.

FIGS. 5A and 5B are side views of a segmented structure respectively in a storage position and in a translated position.

FIGS. 6A and 6B to 12A and 12B show, respectively in a schematic view and in a perspective view, various successive steps of deploying secondary panels with respect to a main panel of a segmented structure.

The segmented structure 1, illustrating the invention and shown schematically in FIG. 1 in particular, is intended, more specifically although not exclusively, for an antenna reflector of a telecommunications satellite. Such an antenna reflector, when deployed in space, generally has a rigid structure (referred to as a shell) which is provided with a reflective surface, as well as reinforcing and support means (not shown) on the rear of said structure, which are involved in supporting the shell and linking with the satellite. In particular for reasons relating to the overall dimensions during the launch of the satellite by a space launcher, said structure is of the segmented type, i.e. it is formed of a plurality of segments or panels.

More precisely, the present invention relates to a segmented structure 1 comprising, as shown in FIG. 1:
at least two panels, namely at least one first panel 2, referred to as the main panel, having a front face 2A and a rear face 2B, and at least one second panel 3, 4, referred to as the secondary panel, also comprising a front face 3A, 4A and a rear face 3B, 4B; and
at least one deployment device 5 which is connected to the respective rear faces 2B and 3B, 4B of the main panel 2 and of a secondary panel 3, 4.

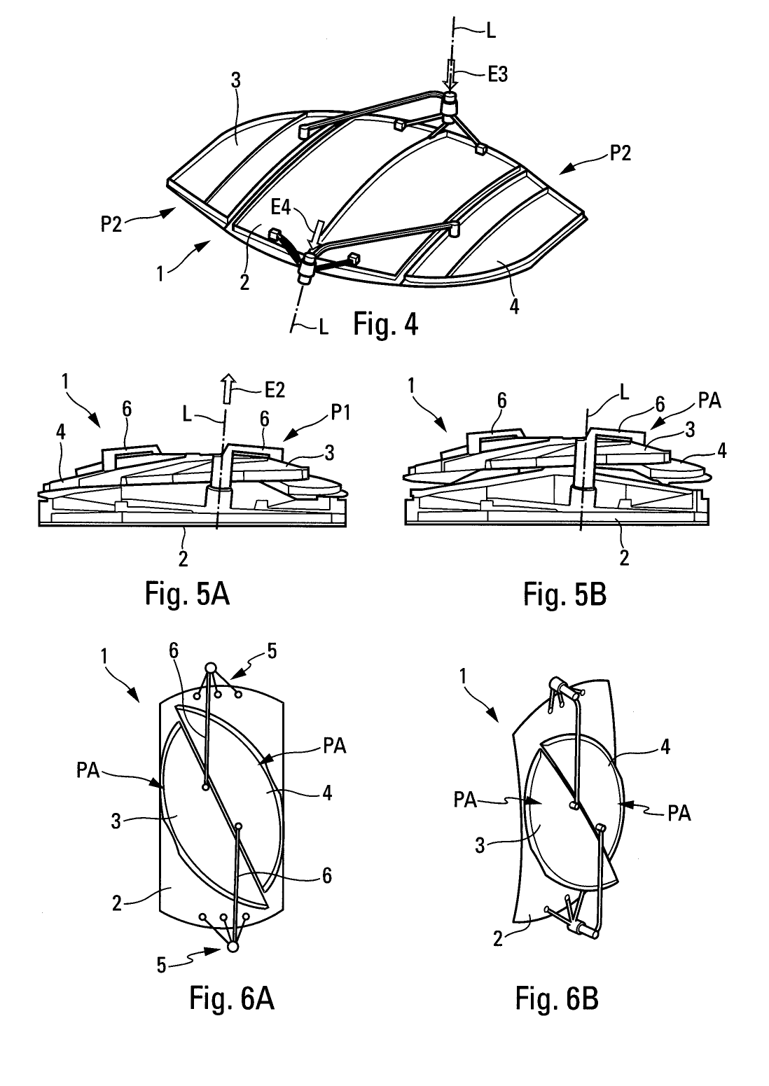

Said deployment device 5 is suitable for bringing the secondary panel 3, 4, with which it is associated, into one or the other of the two following positions, relative to the main panel 2:
a storage position P1 as shown in FIGS. 1 and 2, in which said secondary panel 3, 4 is positioned at least in part, and preferably completely positioned, on the main panel 2 on the rear face 2B thereof. The front face 3A, 4A of the secondary panel 3, 4 is directed in the same direction as the front face 2A of the main panel 2; and
a deployed position P2 as shown in FIGS. 4, 12A and 12B, in which the secondary panel 3, 4 is positioned to the side and against the main panel 2 in order to form a continuous assembly at least on the front faces 2A and 3A, 4A thereof.

In the description of the present invention, “front face” and “rear face” are understood to mean the two faces of a panel, the front face 3A, 4A of a secondary panel 3, 4 being positioned at least in part on the rear face 2B of the main panel 2, each front face 2A, 3A, 4A corresponding in the case of an antenna reflector to the reflective face.

In the preferred embodiment, depicted in the drawings, the segmented structure 1, having an axis of symmetry X-X (FIG. 1), comprises:
a central main panel 2;
two secondary panels 3 and 4 arranged on either side of said central main panel 2 in the fully deployed position (FIG. 4) in such a way that these three panels 2, 3 and 4 have a parabolic shape in said fully deployed position; and
two deployment devices 5 respectively associated with said secondary panels 3 and 4.

According to the invention, each of the deployment devices 5 of the segmented structure 1, as shown in FIG. 1, comprises:
a link arm 6 which is rigidly connected, by a first 6A of the ends thereof, to the rear face 3B, 4B of said secondary panel 3, 4 and which is connected, by a second 6B of the ends thereof, to the rear face 2B of said main panel 2 by means of a structural portion 7; and
a movement system 8 arranged in said structural portion 7.

According to the invention, said movement system 8 comprises:
a rotation unit 9 (FIG. 3) suitable for rotating the link arm 6. The link arm 6 is arranged such that a rotation of the rotation unit 9 allows the secondary panel 3, 4 to be brought directly into one or the other of a first position PA (FIGS. 6A and 6B) and a second position PB (FIGS. 8A and 8B) relative to said main panel 2. Said first and second positions PA and PB laterally (that is to say in a lateral plane substantially corresponding to the average plane of the main panel 2) correspond substantially to the storage position P1 and a position associated with the deployed position P2, respectively. This associated position may be either directly the deployed position P2 or a position Pi close to said deployed position; and
a translation unit 10 (FIG. 2) suitable for translating the link arm 6 so as to move the secondary panel 3, 4 relative to the main panel 2 in a transverse direction (axis L) which is substantially transverse to the main panel 2.

The rotation unit 9 is formed to rotate the link arm 6 about a reference axis L, as shown by an arrow F1, F2 in FIG. 3, and the translation unit 10 is formed to translate the link arm 6 along the same reference axis L, as shown by an arrow E1, E2 in FIG. 2. Preferably, said reference axis L is defined by the combination of the plane of interface between the relevant secondary panel 3, 4 and the main panel 2 in the storage position P1 and in the deployed position P2, with the relative position of said secondary panel 3, 4 and of said main panel 2.

Such a deployment device 5 makes it possible to carry out effective and advantageous deployment of the secondary panel 3, 4, with which it is associated, from the storage position P1 to the deployed position P2, as specified below.

Furthermore, the segmented structure 1 may comprise conventional systems (not shown) for fixing the different panels 2, 3 and 4 in the storage position P1. These fixing systems are released before deployment, so that each deployment device 5 can implement the deployment specified below.

The movement system 8 for each secondary panel 3, 4 allows the successive translation and rotation movements that are necessary for disengaging jettisonable fixing systems, for deploying the secondary panel 3, 4 and capturing said panel. Each movement system 8 is arranged on the structure 7. Said structure 7 comprises a structural element (or support member) 13 that is fixed to the central main panel 2 by means of fixing feet 14, for example by means of three feet 14 (FIG. 3).

The link arm 6 ensures the transmission of the translation and rotation movements between the movement (or motorisation) system 8 and the secondary panel 3, 4. Each arm 6 is connected to the secondary panel 3, 4 and to the motorisation system by a housing 11 (only shown in FIG. 2 in order to simplify the drawings). In order to limit redundant support elements and to allow alignment and capture of each secondary panel 3, 4 relative to the main panel 2, the housing of the arms on the secondary panel 3, 4 has flexibility produced by a flexible element 12 (only shown in FIG. 2 in order to simplify the drawings), which is provided for all degrees of freedom.

The present invention therefore provides pivoting and translation, along the same axis L, the secondary panel 3, 4 from the storage position P1 to the deployed position P2 thereof. The translation allows the offset necessary for placing the structures on top of one another.

In a preferred embodiment, each rotation unit 9 comprises an electric motor (not shown) coupled to a reduction gear and acting between the structural portion 13 rigidly connected to the rear face 2B of the main panel 2 and the end 6B of the link arm 6.

Furthermore, in a preferred embodiment, each translation unit 10 comprises an electrically actuated screw-nut system (not shown) likewise acting between the structural portion 13 rigidly connected to the rear face 2B of the main panel 2 and the end of the link arm 6.

Different successive positions of a deployment of two secondary panels 3 and 4 are shown in FIGS. 2 to 4. In the example in FIG. 2, the two secondary panels 3 and 4 are stored above the main panel 2. The fixing points (not shown) between the secondary panels 3, 4 and the central main panel 2 are released.

A first phase includes a translation (towards the rear in the direction of the arrows E1 and E2) along the axes L, as shown in FIG. 2, in order to disengage the two secondary panels 3 and 4 from the fixing systems thereof on the main panel 2 in order to bring the secondary panels into the first position PA (FIGS. 6A and 6B). This translation can be carried out simultaneously in order to avoid a collision between the two link arms 6 and the secondary panels 3 and 4, respectively. This translation is likewise shown in FIGS. 5A and 5B, FIG. 5A corresponding to the storage position P1 before translation and FIG. 5B corresponding to the position PA after translation along the reference axis L, as shown by the arrow E2. The link arms 6 have a sliding pivot link at the ends 6B thereof.

A second phase includes a rotation along the axes L in rotation directions indicated by the arrows F1 and F2 in FIG. 3 (in order to move the link arms 6 as shown by the arrows G1 and G2) in order to bring the secondary panels 3, 4 into the second position PB (FIGS. 9A and 9B).

A third phase includes a translation (towards the front) in the directions E3 and E4 opposite the directions E1 and E2, along the axes L in order to engage the secondary panels 3 and 4 in the guiding and capturing systems, which produce a mechanical rigid connection between the secondary panels 3 and 4 and the main panel 2. During this third phase, the flexibility introduced (via the flexible elements 12) in the housings 11 of the link arms 6 on the secondary panels 3 and 4 comes into play.

Furthermore, in a variant, when the capture path has to be located in a plane that is parallel to the average plane of the main panel 2, the rotation of the second phase continues for a few degrees. Then, after the translation of the third phase, a reverse rotation along the axes L in the opposite direction to the directions F1 and F2 is carried out and makes possible the engagement of the secondary panels 3 and 4 in the alignment and capture systems. During said last phase, the flexibility introduced (via the flexible elements 12) in the housings 11 of the link arms 6 on the secondary panels 3 and 4 comes into play.

The deployment devices 5 of the segmented structure 1, which are associated with the different secondary panels 3 and 4 of said segmented structure 1, thus make it possible to carry out a deployment of the segmented structure 1 from a full storage position (in which all the secondary panels 3 and 4 are in a storage position P1) to a fully deployed position (in which all the secondary panels 3 and 4 are in a deployed position P2, as shown in particular in FIG. 4).

The deployment device 5 also comprises means that are not shown (for example a central unit) for controlling in particular the electric motors of the rotation unit 9 and translation unit 10.

In the example of an antenna reflector, the main panel 2 forms the central portion of the antenna reflector. It contains the structures for receiving the movement system 8. This main panel 2 likewise receives the jettisonable fixing systems of the secondary panels 3, 4 when they are in the storage position P1. These elements make it possible for the set of three panels 2, 3 and 4 to tolerate the mechanical (quasi-static and dynamic) conditions during the integration, transport and flight phases. The main panel 2 is likewise provided with customary systems (not shown) for capturing and aligning the secondary panels 3, 4 in the deployed position P2. Furthermore, the main panel 2 is connected to the main payload structure (for example the satellite structure) by means of a deployment arm and jettisonable fixing systems (not shown) of the customary type.

The secondary panels 3, 4 are complementary to the overall reflective surface to be reconstituted. In the storage position P1, said secondary panels are kept on the periphery thereof by the jettisonable fixing systems arranged on the central main panel 2. The lateral secondary panels 3, 4 likewise receive the additional capture and alignment systems.

In the storage position P1 (FIG. 1), the two secondary panels 3, 4 are arranged symmetrically with respect to one another, according to a central symmetry relative to a central point (not shown) of the main panel 2.

The operation of the deployment device 5, for the deployment of a secondary panel 3, 4 from the storage position P1 in FIGS. 1 and 2 into the deployed position P2 in FIGS. 4, 12A and 12B, is as follows:
a) translating, from the storage position P1 of FIG. 2 in particular the link arm 6 to which the secondary panel 3, 4 is connected, in a first translation direction E1, E2 along the corresponding reference axis L by means of the translation unit 10, in order to space said secondary panel 3, 4 from said main panel 2 and to bring said secondary panel into the first position PA (FIGS. 6A and 6B);
b) rotating said link arm 6, to which the secondary panel 3, 4 is connected in a first rotation direction F1, F2 along the corresponding reference axis L by means of the rotation unit 9, in order to bring the secondary panel 3, 4 into the second position PB (FIGS. 8A and 8B); and
c) translating the link arm 6 to which the secondary panel 3, 4 is connected in a second translation direction E3, E4 opposite to said first translation direction E1, E2 by means of the translation unit 10, in order to bring said secondary panel 3, 4 nearer said main panel 2.

An additional step d) can be provided, consisting in rotating the link arm 6 to which the secondary panel 3, 4 is connected in a second rotation direction opposite to the first rotation direction F1, F2 by means of the rotation unit 9, in order to bring said secondary panel 3, 4 in contact with said main panel 2, as shown in FIG. 4 for example.

A more detailed deployment example is shown in FIG. 6A, 6B to 12A, 12B which show different successive steps of deploying the secondary panels 3 and 4 relative to the main panel 2. In each pair of two figures XA and XB, X being a whole number between 6 and 12,

Fig. XA shows a plan view and Fig. XB shows the same view in perspective. In this example, the deployment is shown successively, step by step, each time first for the secondary panel 4, then for the secondary panel 3.

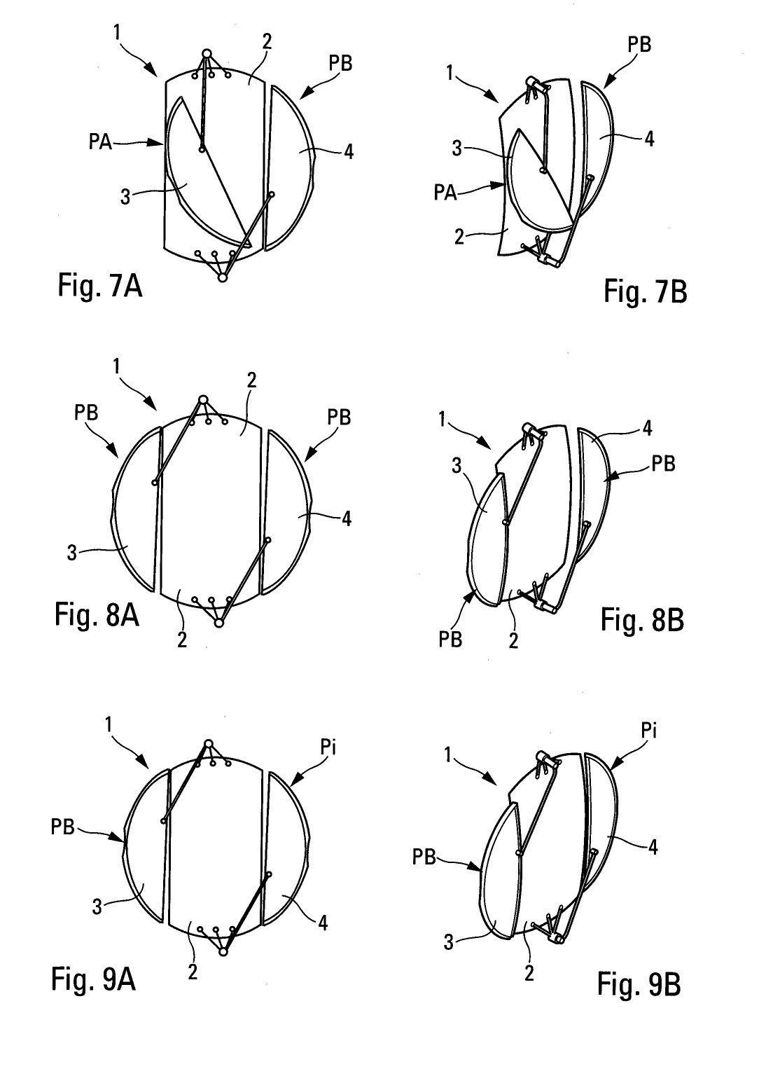

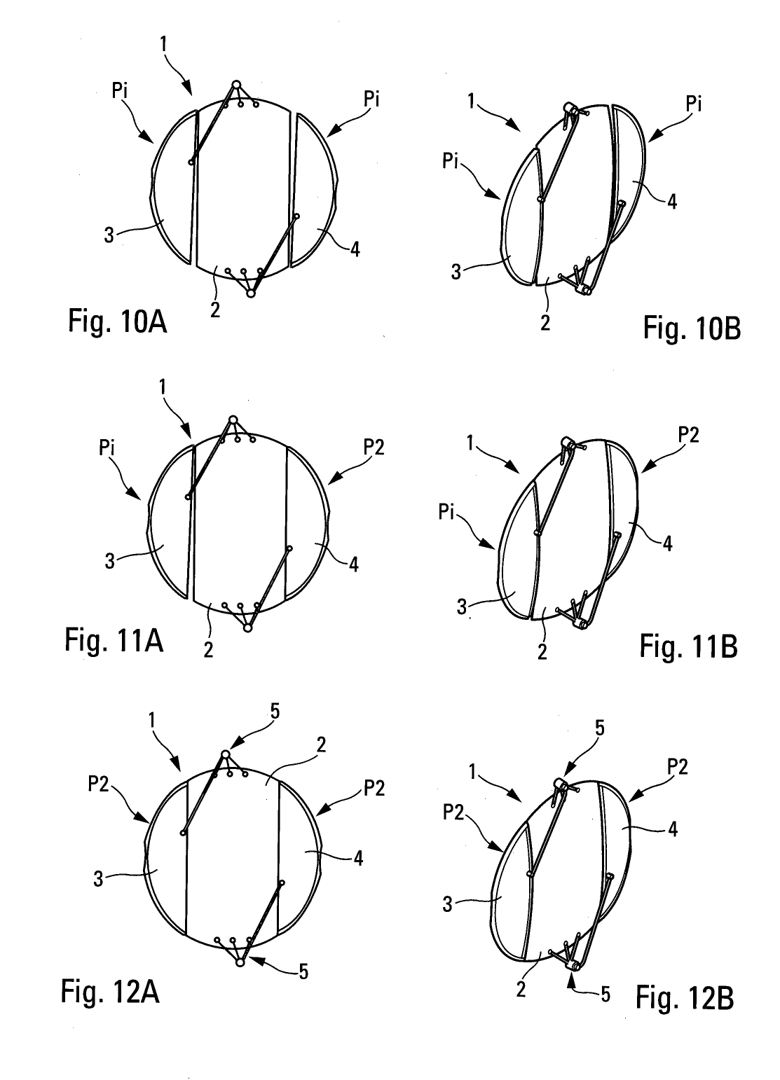

More precisely:
FIGS. 6A and 6B show the secondary panels 3 and 4 in the position PA;
FIGS. 7A and 7B show the result of the rotation (in the direction F2) of the secondary panel 4 from the position PA to the position PB;
FIGS. 8A and 8B show the result of the rotation (in the direction F1) of the secondary panel 3 from the position PA to the position PB;
FIGS. 9A and 9B show the result of the translation (in the direction E4) of the secondary panel 4 from the position PA to the position Pi in the average plane of the main panel 2;
FIGS. 10A and 10B show the result of the translation (in the direction E3) of the secondary panel 3 from the position PB to the position Pi in the average plane of the main panel 2;
FIGS. 11A and 11B show the result of the rotation (in the opposite direction to the direction F2) of the secondary panel 4 from the position Pi to the storage position P2; and
FIGS. 12A and 12B show the result of the rotation (in the opposite direction to the direction F1) of the secondary panel 3 from the position Pi to the storage position P2.

The same deployment method is therefore used for the two secondary panels 3 and 4 so as to obtain a fully deployed position of the segmented structure 1 (FIGS. 12A and 12B).

Of course, the device 5 can also bring the segmented structure 1 from the deployed position P2 into the storage position P1, should that become necessary, for example for a validation operation, by carrying out the above-mentioned operations in reverse order (d, c, b, a), each operation (rotation, translation) being implemented in the opposite direction to that indicated above for the deployment.

The segmented structure 1 also comprises means (not shown) for allowing a precise final positioning between a secondary panel 3, 4 and the main panel 2 as well as means for locking the panels in the fully deployed position of the segmented structure 1.

1. Segmented structure, in particular for a satellite antenna reflector, said segmented structure comprising:
at least two panels, intended to be deployed in space, a first panel referred to as the main panel, comprising a front face and a rear face, and a second panel referred to as the secondary panel, also comprising a front face and a rear face; and
at least one deployment device connected to the respective rear faces of said main and secondary panels and suitable for bringing said secondary panel into one or other of the following two positions, relative to said main panel:
a storage position, in which said secondary panel is positioned at least in part on said main panel on the rear face thereof, the front face of said secondary panel being directed in the same direction as the front face of said main panel; and
a deployed position in which said secondary panel is positioned towards the outside of the main panel, to the side and against said main panel in order to form a continuous assembly at least on the front faces thereof,
said deployment device comprising:
a link arm which is rigidly connected, by a first of the ends thereof, to the rear face of the secondary panel and which is connected, by a second of the ends thereof, to the rear face of the main panel by means of a structural portion; and
a movement system arranged in said structural portion and comprising at least:
a rotation unit suitable for rotating said link arm about an axis referred to as a reference axis, said link arm being arranged such that a rotation of said rotation unit allows said secondary panel to be brought directly into one or the other of a first position and a second position relative to said main panel, said first position and said second position being respectively located, in a lateral plane, substantially in said storage position and in a position associated with the deployed position; and
a translation unit suitable for translating said link arm along said reference axis so as to move said secondary panel relative to said main panel in a direction that is transverse to said lateral plane,
wherein the movement system is configured to carry out successive translation and rotation movements, respectively implemented by the translation unit and by the rotation unit.

2. Segmented structure according to claim 1, wherein said reference axis is defined by the combination of the plane of interface between the secondary panel and the main panel in the storage position and in the deployed position, with the relative position of said secondary and main panels.

3. Segmented structure according to claim 1, wherein said rotation unit comprises an electric motor coupled to a reduction gear and acting between a structural element rigidly connected to the rear face of the main panel and said second end of the link arm.

4. Segmented structure according to claim 1, wherein said translation unit comprises an electrically actuated screw-nut system acting between a structural element rigidly connected to the rear face of the main panel and said second end of the link arm.

5. Segmented structure according to claim 3, wherein said structural element comprises a support that is provided with fixing feet rigidly connected to the rear face of the main panel.

6. Segmented structure according to claim 1, wherein said link arm is connected, in the region of at least one of the ends thereof, by a housing.

7. Segmented structure according to claim 1, wherein said link arm is provided, at least at the first of the ends thereof, with a flexible element.

8. Segmented structure according to claim 1, comprising:
a central main panel;
two secondary panels arranged on either side of said central main panel in the deployed position so as to have a parabolic shape; and
two deployment devices respectively associated with said secondary panels.

9. Segmented structure according to claim 8, wherein, in the storage position, the two secondary panels are arranged symmetrically with respect to one another, according to a central symmetry relative to a central point of said main panel.

10. Satellite antenna reflector, comprising a segmented structure according to claim 1.

11. Satellite comprising at least one segmented structure according to claim 1.

12. Method for deploying a segmented structure according to claim 1, said method comprising successive steps, during deployment from the storage position to the deployed position, of:
a) translating the link arm, to which the secondary panel is connected in a first translation direction by means of the translation unit, in order to space said secondary panel from said main panel and to bring said secondary panel into said first position;
b) rotating said link arm, to which the secondary panel is connected in a first rotation direction by means of the rotation unit, in order to bring the secondary panel into said second position; and
c) translating the link arm, to which the secondary panel is connected in a second translation direction opposite to said first translation direction by means of the translation unit, in order to bring said secondary panel substantially into the same average plane as said main panel.

13. Deployment method according to claim 12, comprising a step d) consisting in rotating said link arm to which the secondary panel is connected, in a second rotation direction opposite to said first rotation direction by means of the rotation unit, in order to bring said secondary panel in contact with said main panel in the deployed position.

14. Method for deploying a segmented structure according to claim 8, said method comprising successive steps, during deployment from the storage position to the deployed position, of:
a) translating the link arm, to which the secondary panel is connected in a first translation direction by means of the translation unit, in order to space said secondary panel from said main panel and to bring said secondary panel into said first position;
b) rotating said link arm, to which the secondary panel is connected in a first rotation direction by means of the rotation unit, in order to bring the secondary panel into said second position; and
c) translating the link arm, to which the secondary panel is connected in a second translation direction opposite to said first translation direction by means of the translation unit, in order to bring said secondary panel substantially into the same average plane as said main panel, wherein the translations and rotations of the two secondary panels are carried out simultaneously.
